(19) United States
(12) Patent Application Publication
(10) Pub. No.: US 2005/0121540 A1
(43) Pub. Date: Jun. 9, 2005

(54) Mist generating device

(76) Inventor: Kenji Torigoe, Aichi (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/504,857

(22) PCT Filed: Feb. 28, 2003
(86) PCT No.: PCT/JP03/02296

(30) Foreign Application Priority Data
Mar. 1, 2002 (JP) 2002-056336
Feb. 12, 2003 (JP) 2003-033971

(51) Int. Cl. B05B 1/28

(52) U.S. Cl. 239/289; 239/135; 239/329; 239/120

(57) ABSTRACT

It is an object to provide a mist generating apparatus for enjoying a low-temperature sauna in a bathroom even when a bathtub does not have a water heating apparatus. A casing is divided into a storage chamber 4, a pump chamber 5, a waterwheel chamber 7 and a mist chamber 6. The storage chamber 4 is provided with a water storage tank 4a having a heater 4d, while the pump chamber 5 is provided with a pump 5a. A waterwheel 1 located in the waterwheel chamber 7 and a fan 2 located in the mist chamber 6 are provided around a rotating axis 3 so as to rotate together, and then warm water in the water storage tank 4a is sprayed to the waterwheel 1 by means of the pump 5, whereby mist is generated. The generated mist is guided to the mist chamber 6 by means of the fan 2 with warm air from a warm air generator 12 and is discharged from an outlet 6a.

### TECHNICAL FIELD

The present invention relates to a mist generating apparatus for a low-temperature sauna which can be easily used in a bathroom.

### PRIOR ART

Presently there are various methods for generating mist. In these methods, an overwhelmingly popular method for generating mist is to spray relatively warm water to a waterwheel, because the low-temperature sauna is enjoyed in bathrooms and a flash water heater with a relatively warm water shower is in prevalence. Thus, demand for such kind of mist generating apparatus is rapidly increasing.

This kind of mist generating apparatuses obtain a high reputation for generating negative ions by the action of Lenard's effect, and many people are interested in it.

As described above, a conventional mist generating apparatus works as follows: relatively warm water is sprayed to a waterwheel and fine water drops generated by spraying are used as mist. Therefore, a bathroom becomes a low-temperature sauna room in a few minutes by connecting a hose tip not to a shower nozzle but to the apparatus, and turning on a faucet.

It is true that no customer's complaint about setting of the apparatus is heard because connecting a hose of the flash water heater in his bathroom to the apparatus is a simple step. Further, even if a flash water heater is not provided in his bathroom, plumbing is easy as long as a water heating apparatus is installed.

However, according to survey, many potential buyers who use old-styled bath heaters desire to set a mist generating apparatus with a simple plumbing even when a water heating apparatus is not installed in their bathrooms.

Moreover, in the conventional apparatus, warm water is inefficiently used since no more than 5% of the warm water turns into mist when it is sprayed to the waterwheel, while the rest of the warm water just runs down as warm water.

### DISCLOSURE OF THE INVENTION

An object of the invention is to provide a mist generating apparatus which has an increased warm water efficiency and is utilized in bathrooms even where a water heating apparatus is not installed. The apparatus includes a waterwheel, a fan, a water storage tank, a pump that sprays water in the water storage tank to wings of the waterwheel so as to rotate the waterwheel, a waterwheel chamber which covers at least the whole waterwheel and includes a fresh air inlet, and a mist chamber which covers the entire fan, including an inlet to which the rotating fan guides mist, which is generated when the water is sprayed to the waterwheel, from the waterwheel chamber, and includes an outlet for discharging the guided mist outside using the rotating fan. It further includes a drained water collecting means which collects drained water splashed and dripped while being sprayed to the waterwheel and returns it to the water storage tank, a heater which maintains the temperature of water in the water storage tank at appropriate temperature, and a power code which receives electric power from commercial power source.

It should be noted that the waterwheel and the fan may be coaxial or connected with each other through a rotation transmission mechanism and that a heater may be provided with the water storage tank. In addition, the waterwheel chamber and the mist chamber may be integrated and a wall having the mist inlet is provided for separating an area in which the waterwheel is disposed and an area in which the fan is disposed. The water storage tank may be disposed under the mist chamber, and a sterilization apparatus may be incorporated.

Moreover, a mist heating means may be provided with the mist generating apparatus and it is desirable to use a warm air generator as the mist heating means.

### BRIEF DESCRIPTION OF THE DRAWINGS

FIG. 1 is an explanatory view of a mist generating apparatus according to the present invention.

FIG. 2 is an explanatory view of a modification of the present invention.

FIG. 3 is an explanatory view of a modification in which a mist heating means is added.

FIG. 4 is an explanatory view of a modification in which a warm air generator is adopted as a mist heating means.

### PREFERRED EMBODIMENTS OF THE INVENTION

Embodiments of a mist generating apparatus according to the present invention will be explained with reference to the drawings.

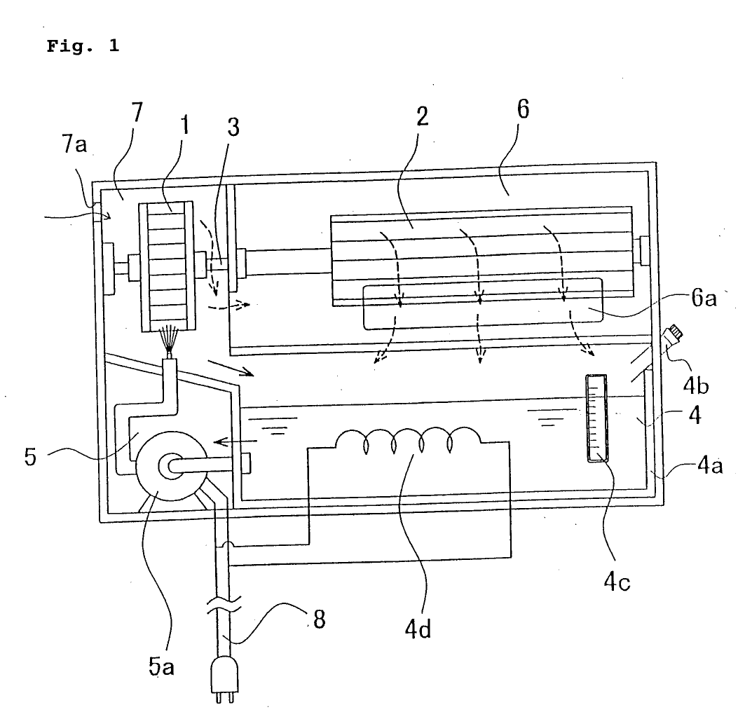

FIG. 1 is a mist generating apparatus in which all elements except a power code are housed in a case, thereby having a neat appearance. The reference number 1 denotes a waterwheel and the reference number 2 denotes a fan, and both are provided around a rotating axis 3 having two ends supported so as to rotate freely. Accordingly, the waterwheel, the fan and the rotating axis can rotate together.

The case has the upper portion and the lower portion; the lower portion is divided into a storage chamber 4 and a pump chamber 5, and the upper portion is occupied with a mist chamber 6 and a waterwheel chamber 7.

The storage chamber 4 has a built-in water storage tank 4a, a water inlet 4b, an inspection hole 4c and a heater 4d which is installed therein.

The pump chamber 5 adjacent to the storage chamber 4 has a pump 5a which suctions warm water in the water storage tank 4a and sprays the same to the waterwheel 1 disposed in the waterwheel chamber 7 located at the upper portion.

The bottom part of the waterwheel chamber 7 is sloping down toward the storage chamber 4 to communicate with the same, whereby a drained water collecting means is established in which drips of drained water are introduced to the storage chamber.

The mist chamber 6 also communicates with the waterwheel chamber 7. Accordingly, when mist is generated in the mist chamber 7 by spraying warm water to the waterwheel, the mist is introduced to the mist chamber 6 by means of the fan 2 rotating together with the waterwheel 1. Then, the mist is discharged from an outlet 6a opening at the front of the mist chamber 6.

The waterwheel chamber 7 has a fresh air inlet 7a in order to help the flow of the mist into the mist chamber 6.

The reference number 8 is a power code to provide electricity to the heater 4d and the pump 5a from commercial power source. Electric isolation, water leak prevention are established in the case and further a perfect temperature management system is performed by sensors disposed at several places and a built-in computer (not shown).

In the mist generating apparatus configured in this manner, first, water is poured into the water storage tank 4a through the water inlet 4b until it reaches a predetermined amount. Then, the water inlet 4b is closed and the electric power is turned ON, that is, the mist generating apparatus is in a standby mode until the water temperature reaches an appropriate level.

When the water in the water storage tank 4 reaches the appropriate temperature, notification is performed, for example, a red lamp showing a standby mode turns into a blue lamp showing an operation mode, and the pump 5a operates automatically.

When warm water in the water storage tank 4a is sprayed to the waterwheel 1 by means of the pump 5a, the waterwheel 1 is rotated, and accordingly, the fan 2 is rotated. Thereafter, the waterwheel chamber 7 is filled with splashed water, some of which becomes fine water drips to be suctioned into the mist chamber 6, and the other drops downward and becomes drained water to be collected into the water storage tank 4a.

Mist in the mist chamber 6 is gashed out from the outlet 6a intensively and a bathroom is filled with the mist.

The temperature of the water storage tank 4a is kept at an appropriate level coordinating with the temperature of the discharged mist.

The mist generating apparatus thus configured is portable, so that it can be mounted at any place as long as the electric power is obtained. Moreover, it can operate without a water heating apparatus. Particularly, in the apparatus of the above embodiment, as the waterwheel and the fan rotate together around the same axis, it is unnecessary to provide driving power to rotate the fan.

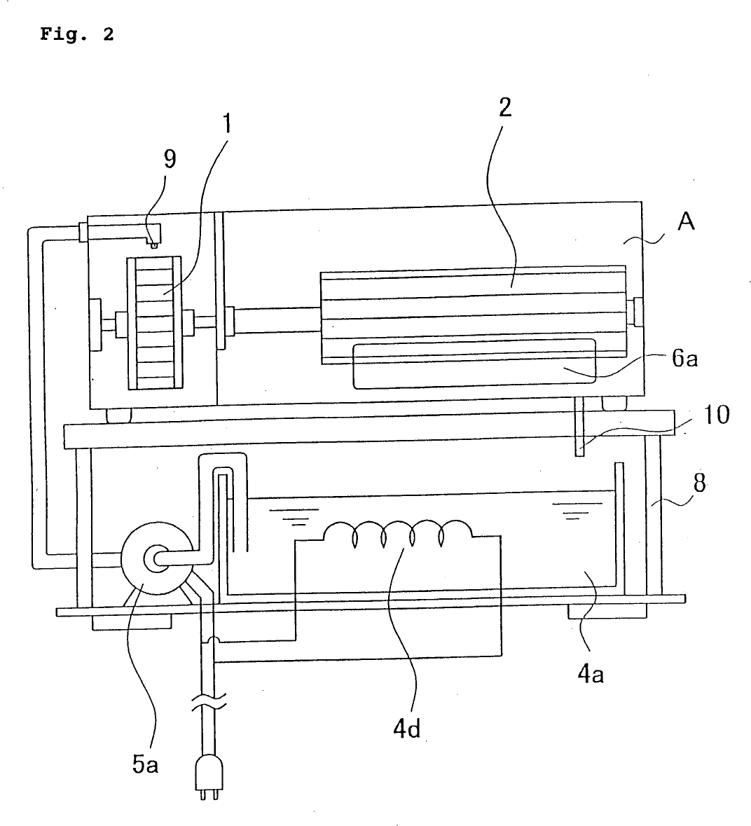

The above embodiment is a unit type in which the water storage tank and the pump are incorporated in the case, but the apparatus of the present invention is not limited to the above embodiment. As shown in FIG. 2, the present invention is applicable to a separate type as follows. First, a conventional mist generating unit A using warm water provided from a water heating apparatus or a flash water heater is disposed on a rack 8, which has a water storage tank 4a and a pump 5a. Thereafter, a nozzle 9 for spraying the warm water to a waterwheel is connected with a pipe from the pump 5a, and drained water in the mist generating unit A is discharged into the water storage tank 4a via a drained water outlet 10. With this configuration, drained water can be collected efficiently, and a user can select one structure either the single mist generating unit or the mist generating apparatus including the unit, tank and pump.

The heater can be mounted at any place on a circulation route, and it is effective to conduct temperature management if the heater is disposed in the water storage tank. Moreover, a sub tank may be provided between the waterwheel chamber (the mist chamber) and the water storage tank. In the sub tank, cooled water collected as drain water is boiled, thereby a sudden change of water temperature in the tank can be prevented even if heating power of the heater in the water storage tank is not high. In addition, Legionella bacteria are killed with a sterilization effect by the heating.

Besides the above-mentioned sub tank with a heater for sterilization, a sterilization apparatus such as an ozone generator may be applied.

The fan may be driven by a motor which is separately provided, other than the above-mentioned structure in which the fan rotates with the waterwheel together.

In a cold season, temperature of warm water is likely to drop significantly.

The above problem is overcome to some extent by intensifying the heater in the water storage tank. However, increasing of electric power consumption is not desirable and when it is cold in the bathroom a user feels still cold even if mist itself is at a hot temperature, so that the user cannot obtain the feeling of sauna bath.

In order to resolve the problem, a mist heating means can be added.

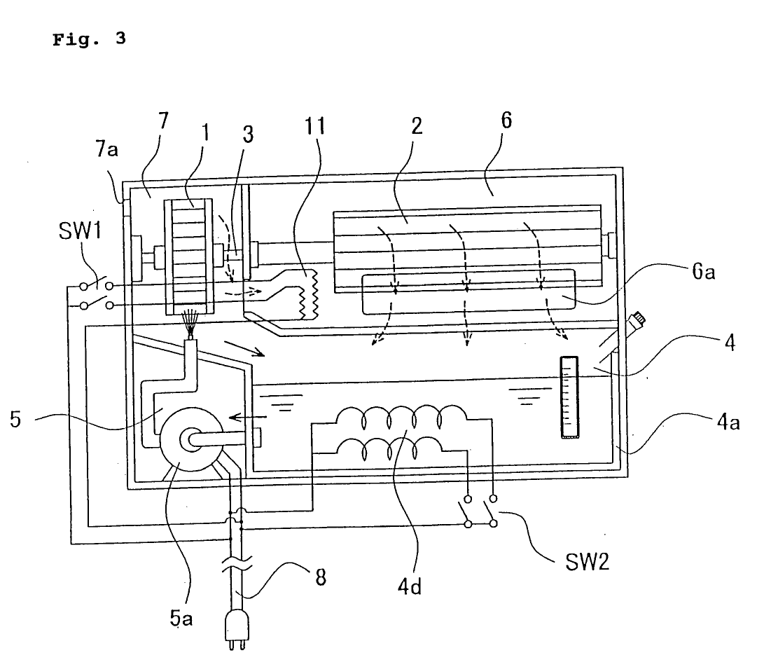

FIG. 3 shows an embodiment in which heating performance is intensified by adding the mist heating means. The feature which are the same as the prior embodiment are denoted same reference numbers and will not be explained.

In the mist chamber 6, a heater 11 as a mist heating means is incorporated.

The heater 11 is a drip-proof type, and as a pair of heaters is provided, it is possible to switch heating power to high/low by means of a switch SW1.

Further, a heater 4d is provided in the storage chamber 4. In this heater 4d, it is possible to switch heating power to high/low by means of a switch SW2.

As the mist chamber 6 can be heated, it is possible to maintain the temperature of mist discharged from the outlet 6a at high temperature, so that the user can obtain the feeling of sauna bath pleasantly even when it is extremely cold.

In addition, as the mist chamber and the storage chamber apply the heater where heating power can be switched to high/low, the best combination in heat efficiency can be selected by changing the heating power of the heater 11 and 4d to high/low according to use conditions.

This is effective to achieve power saving.

Other than incorporating the heater into the mist chamber, the mist heating apparatus can be provided with a built-in or an external warm air generator.

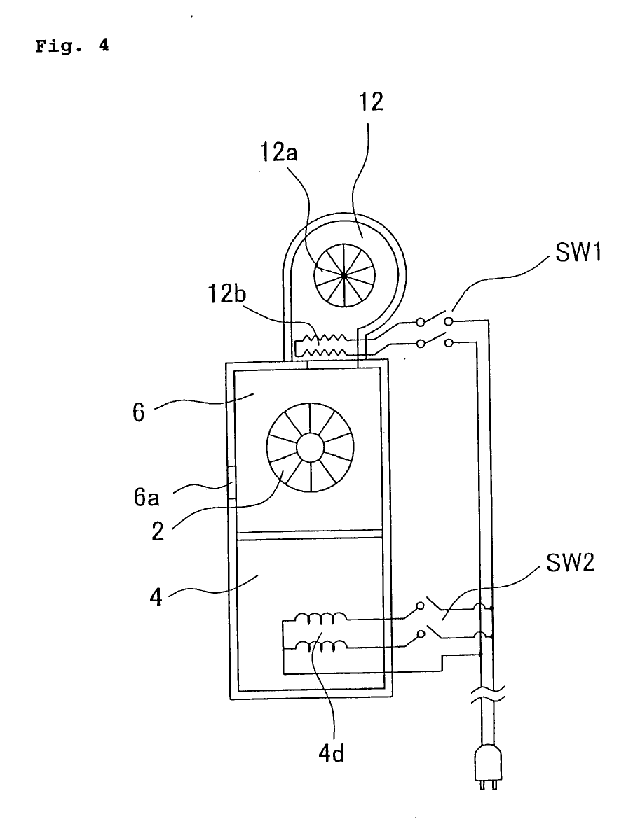

FIG. 4 shows an example of an external warm air generator. On the mist chamber 6 a warm air generator 12 is located in order to blow warm air compulsory into the mist chamber 6.

The warm air generator 12 has a heater 12b which is incorporated into an outlet of a blower 12a, which is similar to hair dryers as home electric appliances.

Also in the mist generating apparatus of this embodiment, a heater 4d is installed in the water storage tank 4. In both the heater 4d installed in the water storage tank 4d and the heater 12b installed in the warm air generator 12, heating power can be switched to high/low by switches SW1, SW2.

In the mist generating apparatus formed in this manner, temperature rise in the initial operation is quick and the cold bathroom can obtain fine sauna condition in a short time because the heater 4d is installed in the water storage tank 4 in addition to the heater 12b.

Further, since the warm air generator 12 is provided externally, it may be an option which a purchaser can add to his apparatus in accordance with his need.

### INDUSTRIAL APPLICABILITY

According to the invention, additional warm water supply is unnecessary and utilization ratio of water can be almost 100% because no drained water is discharged from the case. Moreover, the apparatus is portable, so that low-temperature sauna can be enjoyed in any kind of bathrooms as long as power source is provided.

In addition, when the waterwheel and the fan are coaxial or connected with each other through a rotation transmission mechanism, a power source for driving the fan is unnecessary. Moreover, when a heater is provided with the water storage tank, temperature management can be done more accurately.

Further, a mist chamber can be used as a mist generating unit when the waterwheel is disposed in the mist chamber and a wall including a mist inlet is provided between an area where the waterwheel is disposed and an area where the fan is disposed. Moreover, when the water storage tank is provided below the waterwheel in the waterwheel area of the mist chamber, drained water can be collected efficiently. Further, when a sterilization apparatus is provided in the water storage tank, an increase of Legionella bacteria can be prevented.

Further, when the mist heating means is applied, fine sauna condition can be obtained in a cold bathroom even if it is extremely cold outside. Particularly, when a warm air generator is added as the mist heating means, it is likely to save time for temperature rise in the bathroom.

1. A mist generating apparatus comprising:
a waterwheel;
a fan;
a water storage tank;
a pump that sprays water in the water storage tank to wings of the waterwheel so as to rotate the waterwheel;
a waterwheel chamber which covers at least the whole waterwheel and includes a fresh air inlet;
a mist chamber which covers the entire fan, and includes an inlet to which the rotating fan guides mist from the waterwheel chamber, the mist generated when the water is sprayed to the waterwheel, and an outlet for discharging the guided mist outside using the rotating fan;
a drained water collecting means which collects and returns the drained water into the water storage tank, the drained water splashing and dripping when it is sprayed to the waterwheel;
a heater which maintains the temperature of water in the water storage tank at appropriate temperature, and
a power code which receives electric power from commercial power source.

2. A mist generating apparatus according to claim 1, wherein the waterwheel and the fan are coaxial or connected with each other through a rotation transmission mechanism.

3. A mist generating apparatus according to claim 1, wherein a heater is disposed in the water storage tank.

4. A mist generating apparatus according to claim 1, wherein the waterwheel chamber and the mist chamber are integrated and a wall having the mist inlet is provided for separating an area in which the waterwheel is disposed and an area in which the fan is disposed.

5. A mist generating apparatus according to claim 4, wherein the water storage tank is disposed under the mist chamber.

6. A mist generating apparatus according to claim 1, wherein a sterilization apparatus is incorporated.

7. A mist generating apparatus according to claim 1, wherein a mist heating means is provided.

8. A mist generating apparatus according to claim 7, wherein the mist heating means is a warm air generator.
